(19) United States
(12) Patent Application Publication
(10) Pub. No.: US 2006/0015611 A1
(43) Pub. Date: Jan. 19, 2006

(54) System and method for proactively recognizing an inadequate network connection

(75) Inventors: Raghvendra G. Savoor, Walnut Creek, CA (US); Bruce Alden Schiner, San Leandro, CA (US); John Porter Van Slyke, Lafayette, CA (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, LP

(21) Appl. No.: 10/893,557

(22) Filed: Jul. 16, 2004

(51) Int. Cl. G06F 15/173

(52) U.S. Cl. 709/224

(57) ABSTRACT

A system and method for recognizing an inadequate network connection are disclosed. A method incorporating teachings of the present disclosure may include identifying a plurality of network connections. In practice, each of the plurality of network connections may be providing network access to an associated user. A collection of provisioned parameters for each of the network connections may be maintained in an accessible memory. The collection of provisioned parameters could include, for example, an assigned throughput value and a burst rate throughput value. To facilitate determining if a given link is adequate, an actual utilization value for a given network connection may be calculated from actual usage information. The assigned throughput value of the given connection and the actual utilization value of the given connection may then be considered to determine the adequacy of the connection.

### FIELD OF THE DISCLOSURE

The present disclosure relates to broadband network connections, and more particularly to a system and method for recognizing an inadequate network connection.

### BACKGROUND OF THE DISCLOSURE

A network may be characterized by several factors like who can use the network, the type of traffic the network carries, the medium carrying the traffic, the typical nature of the network's connections, and the transmission technology the network uses. For example, one network may be public and carry circuit switched voice traffic while another may be private and carry packet switched data traffic. Whatever the make-up, most networks facilitate the communication of information between at least two nodes, and as such act as communication networks.

At a physical level, an individual device or network may connect to a broader network via a broadband communication link. This link may be provided, for example, by a digital subscriber line (DSL) modem, a cable modem, a Frame Relay service, a dedicated T1 line, and/or some other interconnection mechanism. However provided, a user of the communication link may not recognize when the link has become inadequate for the user's needs.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements.

Embodiments incorporating teachings of the present disclosure are shown and described with respect to the drawings presented herein, in which:

FIG. 1 presents a flow diagram for an embodiment of a proactive provisioning and utilization auditing technique that incorporates teachings of the present disclosure;

FIG. 2 presents an illustrative diagram of a user interface system to facilitate presentation of information relating to the utilization of a deployed broadband connection in accordance with teachings of the present disclosure; and

FIG. 3 illustrates of one embodiment of a graphical user interface that presents information relating to the adequacy of deployed frame relay services in accordance with teachings of the present disclosure.

### DETAILED DESCRIPTION OF THE DRAWINGS

As mentioned above, many users of network data connections have limited visibility into the adequacy of their respective connections. A user may experience connection problems, faults, lost information, and downtime, and realize too late that these problems resulted from an undersized data connection. A network service provider may elect to provide customer network management (CNM) tools to their users in the hope that these users will use the CNM tools to avoid some of the problems associated with undersized data connections. Unfortunately, many small users, public sector users, and medium sized enterprises forego the expense of the CNM tools. And, those entities that do have the tools often fail to use them properly or lack the ability to properly consider historical and trending data.

The following discussion focuses on a system and a method for proactively recognizing the existence of an inadequate network connection. Much of the discussion involves frame relay services, but the teachings may also be applied to other types of backhaul services. Additionally, while the following discussion seems to center on how a service provider might use some of the teachings disclosed herein to better prioritize its sales efforts and/or to proactively approach customers that are relying on undersized backhaul connections, other entities and organizations could also make use of the teachings disclosed herein. For example, an Information Technology (IT) department may benefit from a system that incorporates some of the teachings disclosed herein. In addition, the techniques described below may also be incorporated into various network nodes and devices, like modems, gateways, softswitches, routers, and other network interface devices (NDs).

From a high level, a method incorporating teachings of the present disclosure may include identifying a plurality of network connections, which may be actual or virtual. In practice, each of the plurality of network connections may be providing network access to an associated user. A collection of provisioned parameters for each of the network connections may be maintained in an accessible memory. In some embodiments, the memory may be centralized and remote from the personnel that may need to access the information. In other embodiments, some or all of the information may be stored in a memory local to the personnel.

In practice, the collection of provisioned parameters could include, for example, an assigned throughput value for a connection, a logical endpoint of the connection, a physical capacity limit for the connection, and/or a burst rate throughput value. A service provider may effectively commit to providing some level of data throughput to a given customer, and parameters relating to, supporting, and/or defining this commitment may make up some portion of the provisioned parameters.

To facilitate determining if a given link is adequate, an actual utilization value for a given network connection may be calculated from actual usage information. In some embodiments, the actual utilization value may represent an average utilization for a user. The average may be calculated, for example, using an appropriate statistical analysis technique. A network operator and/or service provider may access, for example, network repositories that maintain actual data throughput values, indications of lost data, and fault alarms for the given network connection. The assigned throughput value and the actual utilization value for the given connection may then be considered to determine the adequacy of the connection.

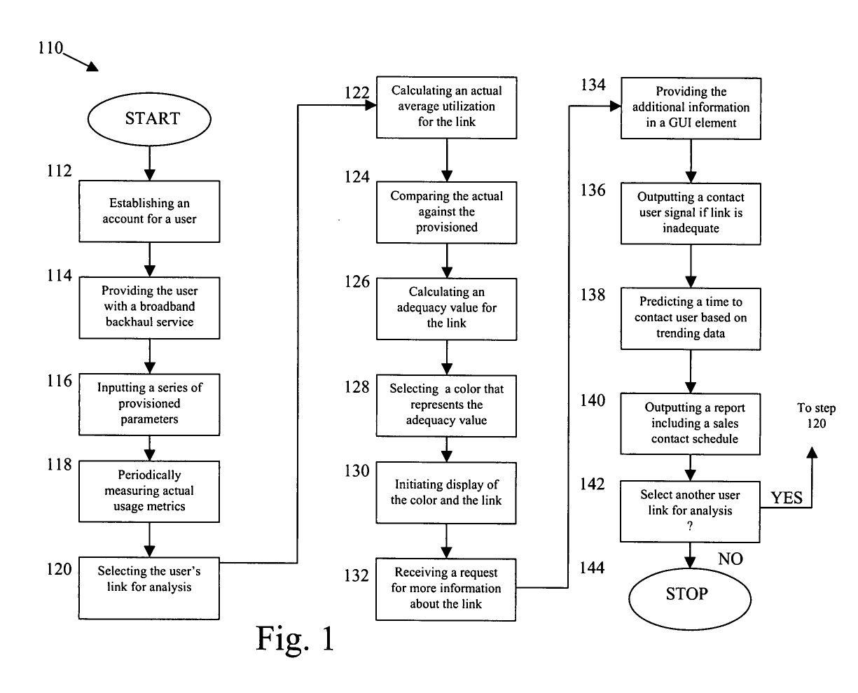

As mentioned above, FIG. 1 presents a flow diagram for an embodiment of a proactive provisioning and utilization auditing technique 110 that incorporates teachings of the present disclosure. At step 112, a user account may be established for an entity requesting a backhaul service. The entity may be an individual, an enterprise, a governmental entity, and/or some other entity requesting the service, and the backhaul service may include frame relay services, DSL services, cable services, dedicated T1 services, other dedicated and/or shared services, and/or some other appropriate backhaul mechanism.

Other backhaul link options may be selectable by the user. For example, the user may choose to make use of Optical Ethernet connections, Asynchronous Transfer Mode (ATM) connections, Internet Protocol (IP) network connections, Synchronous Optical NETwork (SONET) connections, local area wireless connections like 802.11 and fixed wireless offerings, and/or wide area wireless connections. Depending upon implementation detail, a given connection may be logical, physical, virtual, dedicated, and/or shared.

At step 114, the requesting entity may be provided with the backhaul service using an appropriate connection, and at step 116 a series of provisioned parameters may be input into a computing system. The provisioned parameters may represent, for example, a service level and/or throughput levels committed to by the service provider. If, for example, the technique is being applied in connection with the provisioning of frame relay services, provisioned parameters may include a number of committed permanent virtual circuits.

A permanent virtual circuit (PVC) may be viewed as a software-defined logical connection in a network. A feature of frame relay that makes it a highly flexible network technology is that the logical connections and required bandwidth between end points may be selected, and the frame relay network itself may be tasked with worrying about how the physical network is used to achieve the defined connections. In frame relay, the committed bandwidth or committed information rate (CIR) and the two endpoints may be viewed as a PVC, which is defined to the frame relay network devices. In some networks, a user may be allowed to occasionally exceed the committed bandwidth during peak conditions.

In practice, multiple PVCs may share the same physical paths at the same time. To manage the variation in bandwidth requirements expressed in the CIRs, frame relay devices may rely on statistical multiplexing. However, if a user consistently exceeds the committed bandwidth, network performance and data throughput may suffer.

As such, at step 118, actual usage metrics for the backhaul may be gathered. In some embodiments, these metrics may be gathered periodically and the period of metric collection may be in the order of minutes, hours, days, weeks, months, years, etc. In practice, the period chosen may depend in part on the implementation details of a system tasked with performing step 118.

At step 120, a particular link may be selected for link adequacy analysis. In practice, the analysis may be performed on a per link basis and/or in bulk. At step 122, an actual average utilization value may be calculated from the metrics gathered in step 118. The methodology of calculating the utilization value may vary within and/or across implementations of technique 110. For example, when calculating the utilization value, more weight may be given to one or more of the available metrics. In one embodiment, an average actual throughput may be weighted more heavily than an actual peak throughput. In another embodiment, peak throughput may be weighted more heavily than a metric representing the number of actual fault alarms.

However calculated, the actual utilization value may be compared against a provisioned value at step 124. At step 126, this comparison may yield an adequacy value for the link being analyzed. At step 128, a range within which the adequacy value fits may be determined. In the embodiment described in technique 110, the range may be correlated to a color-coded schema. At step 130, a graphical user interface element may be launched. The launched element may include, for example, an identifier for the selected link and a colored icon indicating the range within which the adequacy value fit.

At step 132, a person viewing the GUI element may have requested more information about the link and/or its adequacy value. For example, a salesperson may be viewing the element and may recognize that the selected link is undersized for the user. The salesperson may now want contact information for a user of the selected link so that the salesperson can make the user aware of the potential problems associated with an undersized backhaul and offer the user additional bandwidth. In preferred embodiments, the salesperson may have access to a software utility capable of near real time and seamless enhancement of the user's available bandwidth. If, for example, the user requests additional bandwidth, the salesperson may be able to “automatically” increase the bandwidth via the software utility—avoiding the need for a truck roll and/or some other physical network manipulation.

At step 134, the information requested may be returned in the same or in a different GUI element. If, as suggested above, a user's backhaul is undersized, a contact user signal may be output at step 136. If the backhaul is grossly undersized, the contact user signal may indicate that the user should be contacted as soon as possible. If the backhaul is slightly undersized and/or trending data indicates that the user will soon outgrow the available bandwidth of the backhaul, technique 110 may progress to step 138. At step 138, a time to contact the user may be scheduled in the future, and at step 140, a report may be output that includes a proposed scheduling of sales calls.

At step 142, technique 110 may determine whether to perform another link adequacy analysis. If additional links are to be analyzed, technique 110 may loop back to step 120. If no additional analysis needs to be performed, technique 110 may progress to stop at step 144. Though technique 110 has been described in terms of sequential steps, steps may be added, removed, re-ordered, and/or looped without departing from the teachings disclosed herein. Moreover, one or more parties, devices, modules, engines, etc. may be utilized to perform technique 110.

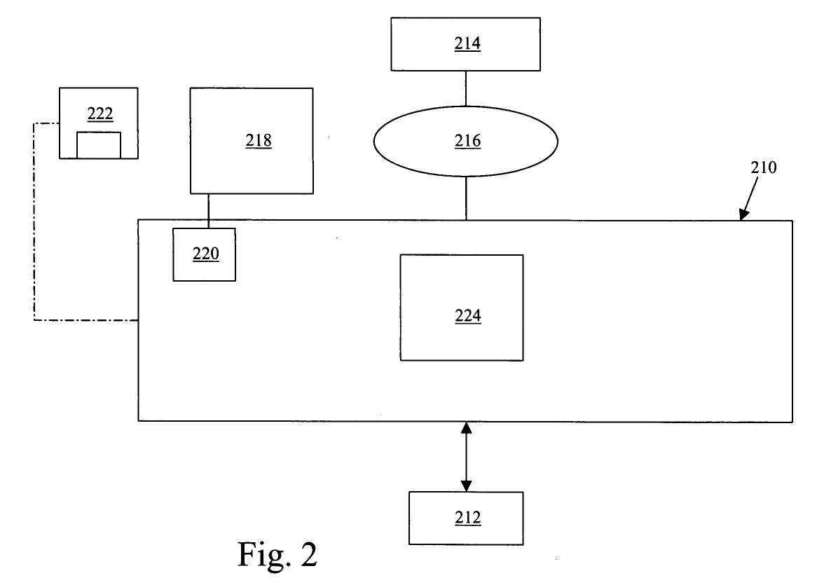

As mentioned above, FIG. 2 presents an illustrative diagram of a user interface system that facilitates presentation of information relating to the utilization of a deployed broadband connection. In the embodiment of FIG. 2, a computer 210 may be accessed by a user 212. User 212 may desire to search information relating to a particular customer's backhaul or a collection of backhauls. In one embodiment, the desired information may be maintained at and/or by another computer 214. In practice, computer 214 may be accessible via network 216.

Examples of computer 210 include, but are not limited to, a desktop computer, a notebook computer, a tablet computer, a smart telephone, and a personal digital assistant. Examples of computer 214 include, but are not limited to, a peer computer, a server computer, and a remote information storage facility. In one embodiment, computer 214 may provide a Web interface via a Web site that provides search functionality and/or other information access and retrieval functionality.

Examples of computer network 216 include, but are not limited to, the Public Internet, an intranet, an extranet, a local area network, and a wide area network. Network 216 may be made up of or include wireless networking elements like 802.11 (x) networks, cellular networks, and satellite networks. Network 216 may be made up of or include wired networking elements like the public switched telephone network (PSTN) and cable networks.

A method incorporating teachings of the present disclosure may include providing a graphical user interface (GUI) using computer 210. The GUI may be presented on display 218 and may allow user 212 to view information relating to a series of customers and their respective backhaul connections. The GUI may also allow user 212 to select a given customer identifier, a link identifier, a link adequacy indicator and/or some other displayed item by activating a selectable GUI icon.

In response to recognizing activation of user-selectable icon, an act of initiating a GUI element may be performed. In one embodiment, display of a given GUI and/or GUI element may be initiated by a display engine 220. Display engine 220 may represent, for example, a processor, hardware, firmware, and/or an executable software application.

In operation, computers 210 and 214 may perform several functions. For example, one or both of computers 210 and 214 may facilitate receiving a selection of one or more icons, activating a selectable icon, and initiating presentation of a given element. Moreover, one or both of computers 210 and 214 may assist in maintaining a collection of provisioned parameters for each of a plurality of network connections, gathering metric data for one of the network connections, calculating an actual utilization value for that network connection, and utilizing the assigned throughput value and the actual utilization value for that connection to generate an adequacy value.

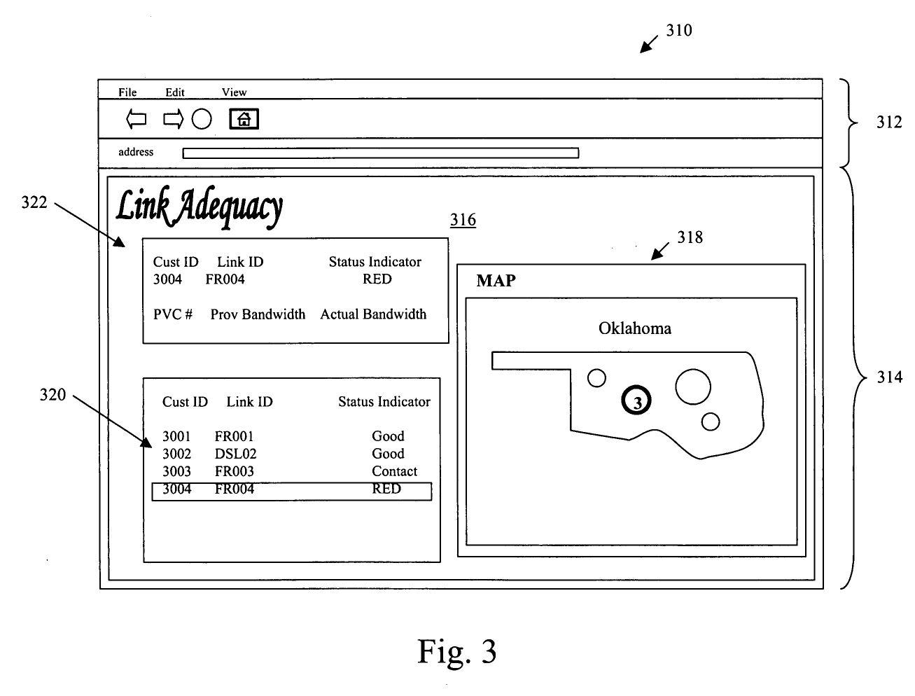

Depending upon implementation detail, computer 210 may perform at least some of these functions and may include a computer readable medium 222 that has instructions for directing a processor like processor 224 to perform those functions. As shown, medium 222 may be a removable medium embodied by a disk, a compact disk, a DVD, a flash with a Universal Serial Bus interface, and/or some other appropriate medium. Similarly, medium 222 may also be an onboard memory made up of RAM, ROM, flash, some other memory component, and/or a combination thereof. In operation, instructions may be executed by a processor like processor 224 that cause display 218 to present user 212 with information about one or more backhaul connections. One example of a link adequacy display that may be presented to user 212 is shown in FIG. 3.

FIG. 3 illustrates one embodiment of a graphical user interface that presents information relating to the adequacy of deployed frame relay services in accordance with teachings of the present disclosure. As shown, a display 310 may include a navigation bar portion 312 and a display pane 314. In operation, a computer like computer 210 of FIG. 2 may have a display device capable of presenting a user with a browser or browser-like screen shot of display 310.

As shown, display 310 may include a GUI 316 that represents a link adequacy display screen. The embodiment depicted in FIG. 3 shows a multiple window structure for GUI 316. This structure may be presented in several other ways. For example, a link adequacy display may be presented in a row-based format—where, for example, a contact name appears at the head of a row and related information appears in subsequent positions of the same row.

In the depicted embodiment, GUI 316 includes a map element in window 318, a selected regional break out in window 320, and a more detailed break out in window 322. In practice, a user may select region “3” in the Oklahoma map presented in window 318. As a result of this selection, window 320 may be launched, which includes more detailed information about the deployed frame relay offerings in the selected region. The more detailed information may include, for example, a customer identifier, a link identifier, and a status indicator. The status indicator may represent a visual indication of the adequacy of the deployed backhaul. As shown, customers “3001” and “3002” appear to have sufficient backhaul capacity. Customer “3003” may be approaching an inadequate condition and may need to be contacted in the near future. Customer “3004” may be in a grossly inadequate state, and this state may be indicated by the “RED” icon.

As shown, a user may have selected customer “3004”, and window 322 may have been launched in response. Window 322 may present additional information about the customer and the link in question. The additional information may include, for example, an actual number of PVCs, the provisioned bandwidth, the actual bandwidth, the customer contact information, as well as the link name and descriptor.

It will be apparent to those skilled in the art that the disclosure herein may be modified in numerous ways and may assume many embodiments other than the preferred forms specifically set out and described herein.

Accordingly, the above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of tracking link adequacy comprising:
identifying a plurality of network connections, each of the plurality of network connections providing network access to an associated user;
maintaining a collection of provisioned parameters for each of the plurality of network connections, the collection of provisioned parameters comprising an assigned throughput value and a burst rate throughput value;
calculating an actual utilization value for each of the plurality of network connections;
selecting a first connection from the plurality of network connections, the first connection associated with a first user; and
utilizing at least an assigned throughput value of the first connection and an actual utilization value of the first connection to generate an adequacy value for the first connection.

2. The method of claim 1 further comprising outputting a contact the first user signal if the adequacy value indicates that the first connection is inadequate.

3. The method of claim 2, further comprising initiating an output of a graphical user interface (GUI) element providing information about the first user in response to the contact the first user signal.

4. The method of claim 1, further comprising outputting a report comprising an identifier for each of the plurality of network connections, a customer identifier for the associated user of each of the plurality of network connections, and an indication of a respective adequacy value for each of the plurality of network connections.

5. The method of claim 4, wherein the indicator comprises a graded color scale and at least one of the plurality of network connections comprises a broadband network connection.

6. The method of claim 1, further comprising considering historical network connection information to calculate the actual utilization value for each of the plurality of network connections

7. The method of claim 6, wherein the historical network connection information comprises an average periodic bandwidth used value, a peak bandwidth used value, and a fault indicator value.

8. The method of claim 7 further comprising periodically collecting the historical network connection information.

9. The method of claim 2 further comprising scheduling a sales contact with the first user in response to the contact the first user signal.

10. The method of claim 2 further comprising determining if the first customer exhibits a pattern of exceeding the assigned throughput value of the first connection.

11. A link tracking system comprising:
a link adequacy display having a first user identifier, a second user identifier, a first connection identifier for a broadband backhaul associated with the first user, a second connection identifier for a broadband backhaul associated with the second user, and a visual indicator operable to show that the broadband backhaul associated with the first user is inadequate; and
a graphical user interface (GUI) operable to present the link adequacy display.

12. The system of claim 11 wherein the visual indicator utilizes a color coded schema to indicate a relative adequacy of a given broadband backhaul.

13. The system of claim 11, further comprising a mapped plotting of a first user location and a second user location.

14. The system of claim 11 wherein the first connection identifier represents a selectable GUI icon capable of being activated to initiate presentation of additional information about the broadband backhaul associated with the first user.

15. The system of claim 11, further comprising a repository maintaining information about a plurality of users having broadband backhauls.

16. The system of claim 15, further comprising a search engine operable to allow an administrator to perform a structured search of information maintained in the repository.

17. The system of claim 11 further comprising a computing platform communicatively coupled to a computer readable medium that comprises a plurality of instructions for instructing the computing platform to collect from remote sources at least a portion of information to be included in the link adequacy display and to initiate presentation of the link adequacy display within the GUI.

18. The system of claim 11, wherein the visual indicator utilizes a color coded schema to indicate a relative adequacy of a given broadband backhaul, further comprising a sales planning engine configured to output a contact first user request if the given broadband backhaul is adjudged inadequate.

19. A computer readable media comprising a plurality of instructions for:
maintaining a collection of provisioned parameters for each of a plurality of network connections, the collection of provisioned parameters comprising an assigned throughput value and a burst rate throughput value;
calculating an actual utilization value for each of the plurality of network connections based on historical information;
selecting a first connection from the plurality of network connections; and
utilizing at least an assigned throughput value of the first connection and an actual utilization value of the first connection to generate an adequacy value for the first connection.

20. The media of claim 19, further comprising instructions for initiating presentation of graphical user interface that comprises a first user-selectable portion representing the adequacy value for the first connection.

21. The media of claim 20, wherein the first user-selectable portion comprises a visual representation of a relative adequacy determined from the adequacy value.

22. The media of claim 21, wherein the visual representation comprises a GUI element having a color, the color selected to show the relative adequacy in accordance with a color coded schema.
